(19) United States
(12) Patent Application Publication
(10) Pub. No.: US 2019/0095245 A1
(43) Pub. Date: Mar. 28, 2019

(54) System and Method for Apportioning Shared Computer Resources

(71) Applicant: CloudHealth Technologies, Inc., Boston, MA (US)

(72) Inventors: Andi Abes, Waltham, MA (US); Efe Yardimci, Lexington, MA (US); Rachel Dines, Somerville, MA (US)

(73) Assignee: CloudHealth Technologies, Inc., Boston, MA (US)

(21) Appl. No.: 15/722,356

(22) Filed: Oct. 2, 2017

Related U.S. Application Data
(60) Provisional application No. 62/562,331, filed on Sep. 22, 2017.

(51) Int. Cl. G06F 9/48; G06F 9/50

(52) U.S. Cl. CPC G06F 9/4881; G06F 9/5038; G06F 9/45558; G06F 9/5077; G06F 9/5083

(57) ABSTRACT

A computer-implemented method of determining value of a shared computer infrastructure to a group includes collecting data from a shared computer infrastructure. An association between one or more workloads and the group based on the collected data is determined using a rule-based engine. A value to the group of the one or more workloads is then determined based on a value allocation rule.

### INTRODUCTION

Businesses are rapidly transitioning their legacy computer infrastructure systems from private computer systems that are typically localized with dedicated computer resources to cloud-based computer infrastructures with virtualized shared computer infrastructure resources. Cloud-based infrastructures typically utilize a large number of varied computer components, including processors, data storage systems, virtual machines (VMs), and containers. Cloud-based computer infrastructures have many potential advantages over legacy computer infrastructures, such as lower costs, improved scaling, faster time-to-deployment of services and applications, expedited service-revenue generation, as well as greater agility and greater flexibility.

Furthermore, the modern needs of IT departments can no longer be served by single computer systems. There has been a strong trend in recent years towards clusters of systems. In these clustered system environments, large collections of individual compute resources, network and storage systems are managed as a single system whose resources are made available to many separate entities. These shared clusters can be efficiently be managed, provisioned and optimized for the benefit of all users.

A compounding trend is higher rates of change in IT environments. Business are continuously employing new technologies, such as machine learning, big data, and containerized software development strategies. Shared among the aforementioned and many other technologies is the need for large amounts of compute, network and storage resources as well as a tendency to have highly variable resource needs.

Billing rules can be complex and can change frequently in short periods of time, especially in cloud environments. In addition, prices can change frequently and for numerous reasons. For example, location (e.g. running in one region is lower than another), usage (e.g. unit price may go down upon achieving certain tiered discounts), what is being provisioned (e.g. a workload may be able to be supported by different VM sizes, each of which may have different pricing), and provider incentive (e.g. cloud provider may incent you to use one type of VM versus another). Also, the value to an organization of the use of cloud-based infrastructures components can vary considerably and rapidly change over time based on the workloads and/or the services provided. There are many ways upon which an organization can determine value for the cloud infrastructure they run, for example cost, service level agreement, availability, reliability, performance, and others. An organization often needs to assess value based on one or more of these criteria at any given time, and this assessment often needs to be done near real time to support business decisions. This value needs to be determined continuously and also may be projected in the future to maximize revenue generation and minimize cost.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a block diagram of a system that apportions value to one or more shared computer infrastructures according to one embodiment of the present teaching.

FIG. 2 illustrates a block diagram describing the data collection and processing functions of a system for apportioning value to shared computer resources according to one embodiment of the present teaching.

FIG. 3 illustrates a block diagram of a distributed system according to one embodiment of the present teaching.

FIG. 4 illustrates a process flow diagram of an embodiment of a computer-implemented method of apportioning value to shared computer resources according to the present teaching.

FIG. 5 illustrates an architecture diagram of an embodiment of a system for apportioning value to shared computer resources according to the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings can be performed in any order and/or simultaneously as long as the teaching remains operable. Furthermore, it should be understood that the apparatus and methods of the present teachings can include any number or all of the described embodiments of steps of the method as long as the teaching remains operable.

The integrated reporting, governance and compliance activities commonly performed by legacy information technology infrastructures are still immature for cloud-based systems and/or systems with a high rate of change. Furthermore, it can be challenging to manage compliance in these shared cloud-based computer infrastructure components.

Clustered, and/or cloud-based computer infrastructure systems are set up to benefit from economies of scale of operations by being configured as shared resources with a centralized set of compute, storage, and networking components which serves many uses and users. However, in such environments, it is challenging to avoid the “unscrupulous diner's dilemma” where consumers of goods who are not held accountable to their share of the good tend to over consume. Providing visibility into the value of a set of shared computer resources that is attributable to each of the various consumers of those shared computer resources provides a much higher degree of accountability than is available with many known computer systems.

It is also inefficient to perform realistic financial accounting, including accounting associated with particular lines of business of an organization with existing computer systems. It is particularly challenging to provide alignment between business value provided by a consumer of the shared infrastructure and their relative resource consumption with existing computer systems.

Businesses can achieve economies of scale when their operations grow to a certain size. The same is true for computer resources. Businesses want to efficiency utilize the computer infrastructure they need to support their business. Efficiency includes many factors such as cost to run and cost to support. As a result, businesses try to achieve optimal density with their infrastructure. That is, they desire to run as many workloads on the smallest and most manageable infrastructure as possible. Consequently, it is important that businesses are able to assign a value to the resources that are consumed in performing various business operations in order for those resources to be apportioned and configured efficiently.

Many state-of-the-art shared computer resources, which are characterized by a set of shared infrastructure, operated at scale by a team of experts with a large and diverse set of consumers who benefit from the shared infrastructure by submitting work-based activities to be performed on the infrastructure and then generating activity in the infrastructure. Inefficiencies in these state-of-the-art shared computer resources resides in their inability to accurately attribute costs resulting from consumption of resources required to perform the work-based activities submitted. In addition to economic costs, there are other important values including, for example, availability of infrastructure, security, and various operational efficiencies. The term “value” can also include a projection, or forecast, of future value.

To help manage cost and efficiency of shared infrastructure, some known systems utilize administrative quotas, whereby a group is provided a set amount of overall resources they're allowed to consume. Groups are then provided with reporting based on these quotas. Quotas are relatively static, and can be much higher than actual activity resource required, resulting in inefficient use of resources and higher costs. Some prior art systems utilize dynamic dedicated resources. In these systems, groups are provided with dynamic infrastructure that is dedicated to their needs (e.g. a group would own a whole cluster). While this improves accuracy over the quota approach, it increases administrative costs in managing individual environments.

Another approach to assign value is top-down modeling, which is defining a model to approximate the value. This can be achieved, for example, with a spreadsheet that approximates costs based on some input. This approach has the advantage of providing a partial solution to the problem, but has the disadvantage of being an approximation and never completely accurate.

The system and method of the present teaching overcomes many of the limitations of known shared computer resource allocation methods. For example, one aspect of the present teaching is a scalable and flexible means for tracking various cloud-based computer infrastructure components and, in particular, their value to an organization. It should be understood that this value is not limited to economic value. For example, value could be security value, operational value, or any of a variety of efficiency related values. The system and method of the present teaching provides an automated system and method for apportioning value of shared cloud-based computer infrastructure components and will assist businesses in maximizing cost and efficiency of their use of a cloud-based computer infrastructure.

In one embodiment, the computer-implemented method and computer system for apportioning shared resource value according to the present teaching allows the identification of proportional value to shared infrastructure that is executing heterogeneous activities. That is, the system provides the proportional value of a shared infrastructure amongst two or more different groups that utilize the shared infrastructure. One example of why this is important is the situation of a customer using a collection of servers in the cloud to run workloads via containers. A container is a packaging and execution system that packages all the requirements of an application such that a simple and consistent process can be employed to provision, execute, and update the application. Thus, a container packages all the elements, including libraries and applications, which are required to execute an application, or set of workloads, and then executes the application on a group of servers. One feature of using container systems is that they reduce the number and complexity of software elements that are required as compared to more traditional virtualized machine operating systems. In addition, containers provide isolation of a workload that keeps its resources separate from another workload. The isolation allows the containers to run on same resources without conflict. Containers also provide faster time to startup/shutdown. In addition, containers provide the ability to share resources which enables businesses to achieve greater density of usage of underlying resources.

A customer using a collection of servers in the cloud to run workloads via containers will be challenged to understand the true cost from a business perspective of the work being done by these servers. This is because many applications can be executed on the same servers concurrently, consuming different amounts of resources. Additionally, the same application can be executing on many different servers at the same time, to provide the overall required processing capacity. Multiple factors contribute to the difficulty in determining the true cost of the use of a shared infrastructure. One important factor is that there is a rapid pace of change of containers supporting the workloads. For example, a customer may run millions of containers in a month, and each container may run for durations of seconds or minutes.

The computer-implemented method and computer system for apportioning shared resource value according to the present teaching that allows the identification of proportional cost of shared infrastructure that is executing heterogeneous activities is also useful to customers when a customer is using a collection of servers for the distributed and parallel processing of jobs. In a distributed system, a single user request is distributed to be executed on multiple computer systems comprising a clustered environment. Requests can include queries that extract data and return meaningful results to users. Requests can also include machine learning model-training tasks and many similar scenarios where no single computer system can contain the required amount of data to complete the request. In these scenarios, the distributed systems are designed to decompose the user's request into smaller parts and arrange the user's request for different computer systems within the cluster to perform the required operations. In these systems, it is challenging to identify proportional cost to be apportioned to different requests and to different users of the shared resources of the cluster.

Also, the computer-implemented method and computer system for apportioning shared resource value according to the present teaching, which allows the identification of proportional value to shared infrastructure that is executing heterogeneous activities, is useful to users when different configurations of servers have different costs in different locations at different times. Such a situation is now common in the cloud, as exemplified by providers such as Amazon Web Services (AWS).

In addition, the computer-implemented method and computer system for apportioning shared resource value according to the present teaching that allows the identification of proportional value to shared infrastructure that is executing heterogeneous activities is useful to users when it is difficult to associate specific costs from servers to the particular workloads that are running on these servers. The term “workload” represents the applications and requests as described above, and more generally, represents a computer program which consumes resources of the shared infrastructure.

Many aspects of the present teaching relate to cloud-based computer infrastructures. The terms “cloud” and “cloud-based infrastructure” as used herein include a variety of computing resource, computer services, and networking resources that run over a variety of physical communications infrastructures, including wired and/or wireless infrastructures. These physical communications infrastructures may be privately or publicly owned, used and operated. In particular, it should be understood that the term “cloud” as used herein refers to private clouds, public clouds, and hybrid clouds. The term “private cloud” refers to computer hardware, networking and computer services that run entirely over a private or proprietary infrastructure. The term “public cloud” refers to computer hardware, networking and services that run over the public internet. The term “hybrid cloud” refers to computer hardware, networking and services that utilize infrastructure in both the private cloud and in the public cloud.

One feature of the present teaching is that it allows the apportioning of value of a shared infrastructure to different groups that are running various workloads on a shared container cluster. A container cluster includes a collection of container processes orchestrated by a container engine that runs the control plane processes for the cluster. For example, a cluster engine may include a Kubernetes API server, scheduler, and resource controller. The method and system of the present teaching collects data regarding the resources consumed by workloads during the lifecycle of this container cluster, and uses that data to determine the value, as described further below. The collected data may originate directly from the Kubernetes (or other container engine) system, information provided by the underlying component infrastructure (CPU, servers, etc), and/or tags in the workload provided by the user. The ability to automatically collect and appropriately correlate this collected data to track workload activity that is running on shared container clusters for particular groups advantageously allows the system to apportion value of this shared infrastructure to these different groups.

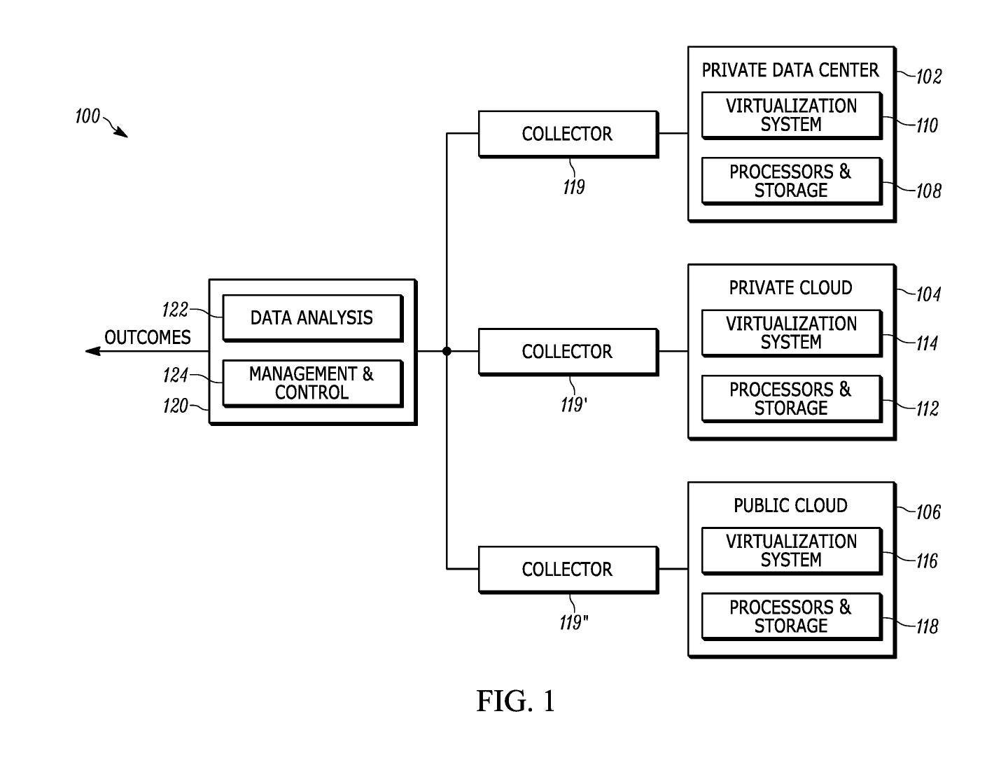

FIG. 1 illustrates a block diagram of a system 100 that apportions value to a user of one or more shared computer infrastructures according to one embodiment of the present teaching. The system 100 collects activity information from various known types of shared infrastructure, including private data centers 102, private clouds 104, and/or public clouds 106. A private data center 102 can, for example, contain a suite of information technology infrastructure or resources 108. The suite of information technology infrastructure or resources 108 can be located on premise at an enterprise, or can be located off site.

For example, the data center 102 can include a set of servers that are running VMware® or other known virtualization software 110 such as XenServer®. A private cloud 104 can contain a suite of information technology infrastructure or resources 112 that are owned and operated by an entity that is separate from the user of the resources 112. This suite of information technology infrastructure or resources 112 is often leased by the user from the separate owner. The private cloud 104 may also run VMware ® or other known virtualization software 114 such as XenServer® that is used to maintain separation of the applications and services running for multiple shared tenants in the private cloud. A public cloud 106 such as, for example Amazon's AWS, Microsoft Azure, and Google Cloud Platform, typically utilize a set of open source software technologies 116 to provide shared-use cloud resources 118 to customers.

The system 100 uses collectors 119, 119′, 119″ that collect, aggregate and validate various forms of activity data from the shared infrastructure platforms 102, 104, 106. The collectors 119, 119′, 119″ may use a variety of approaches to collecting information on usage, cost and/or performance from shared infrastructure platforms 102, 104, 106 and/or its target environment (e.g. a public cloud provider). For example, a collector may include software that runs on a physical server or inside a virtual machine, which is sometimes referred to as an agent. A collector may be software that collects data remotely over a public or private network without the use of an agent, which is sometimes referred to as an aggregator.

In various embodiments, the system and method of the present teaching uses one or both of these collection systems at different locations across the infrastructure. The information data from the collectors 119, 119′, 119″ is then sent to one or more processing platforms 120. In some embodiments, the processing platforms 120 include data storage to store the data coming from different sources. Also, in some embodiments, the processing platforms 120 include predefined input from a user regarding how the user wants to attribute value. For example, value can be proportional to the CPU cycles consumed by the aggregate containers run over a predefined period of time, and value can be defined differently for a different user. These rules regarding how value is attributed can be predefined, or they can change over time. In some embodiments, the method of attributing value is determined by a formula.

The processing platforms 120 include a data analysis processor 122 that determines a value of the resource infrastructure to an organization or user based on the determined rule or formula for apportioning value. In some embodiments, the resource value may be a proportional value of a portion of the resource that is used by a group within the organization. The organization can include one or more groups. The determined value can be assessed against various metrics that can be used to initiate actions on the shared infrastructure, set policies, and provide compliance reporting for the organization by a management and control processor 124. The one or more processing platforms 120 provide outcomes to the organization using the shared resources including reports and actions. For example, an action can include a reconfiguration of the resources in the shared infrastructure that is used to execute a set of workloads that are performed by the user. In various embodiments, the one or more processing platform 120 can operate as multiple processing instances distributed in a cloud. Also, in various embodiments, the one or more collectors 119 can operate as multiple processing instances distributed in a cloud.

One feature of the computer-implemented methods and systems of the present teaching is that users can understand cost from a business perspective of a shared/multi-tenant infrastructure. This allows users to make critical business decisions to drive cost optimization, efficiency, and rightsizing of their shared infrastructure. Users are able to generically collect, process, and analyze information about available resources and consumed resources in a shared infrastructure environment. Users are also able to use the sampled resource consumption to ascribe aggregate resource consumption of the shared infrastructure. In one embodiment, users can use a configurable rules engine to associate resources consuming workloads to a much smaller number of groupings that can be reasoned about by humans. For example, resources consuming workloads may include containers, structured query language (SQL) queries in databases, Cassandra (a widely used NoSQL database) or Spark clusters (a fast general purpose cluster computer system).

Another feature of the computer-implemented methods and systems of the present teaching is that it allows users to intervene and change the use and/or value of a business activity, or set of workloads, that uses shared resources. For example, a user can allocate costs of the shared infrastructure to business entities benefiting from it, proportionally. Further, a user can assess the relative resource consumption (e.g. load exerted) by different workloads.

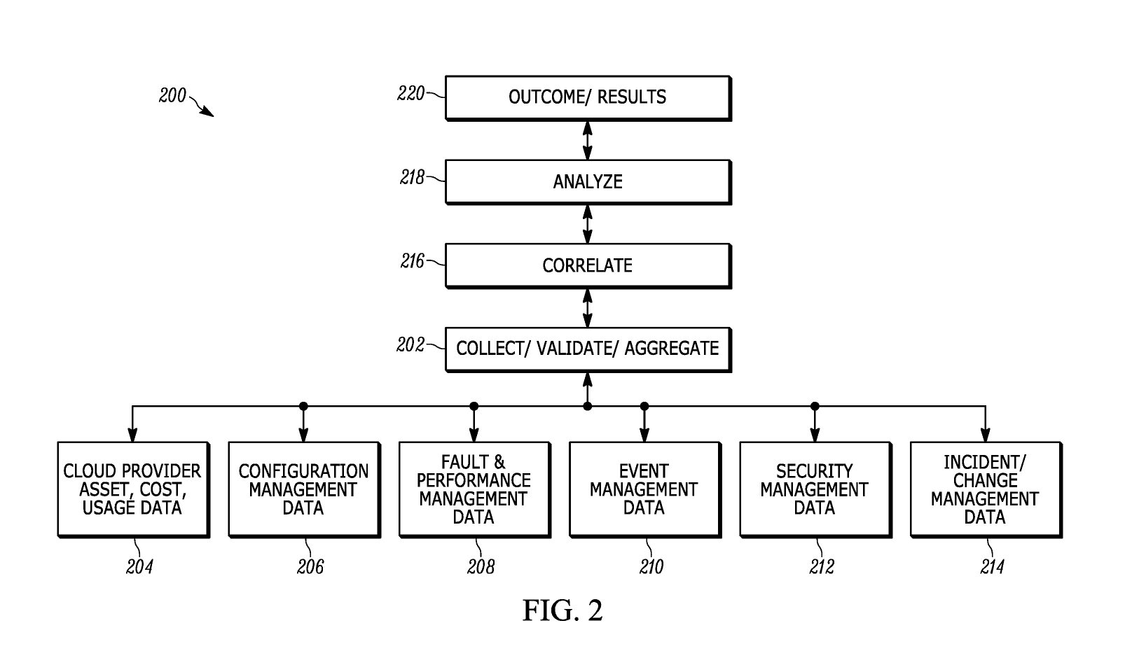

FIG. 2 illustrates a block diagram outlining the data collection and processing functions of an embodiment of a system processor 200 according to one embodiment of the present teaching. The system processor 200 includes a collection validation and aggregation system 202 that collects various data from various processes that run on shared infrastructure. The data include: asset, cost and usage data 204 from a cloud provider; configuration management data 206; fault and performance management data 208; event management data 210; security management data 212; and incident and change management data 214. The data may include availability data, for example, how much CPU is available and how much CPU is used.

After collection, validation and aggregation 202, the data is correlated and associated 216 with various groups. For example, the data can include a log file that has all the activity of containers for a cluster. The correlation phase may identify what VM each container ran on. The metadata allows the association to a specific group by application of a rule-based grouping engine to the data. These groups can include collections of users, which can be, for example, users that operate in the same line of business of an organization. The groups may also be defined by other attributes. For example, a group may represent a particular software application or service, or a collection of activities that support a common business purpose, such as accounting, software development, or marketing. In various embodiments, the groups may be defined by a rule-based engine. Also, the groups can be based on past data collected by the system and often change over time.

In some embodiments, the system and method of the present teaching uses rules and/or formulas to define groups. For example, there are rules for defining what the group is and the group membership. These rules are also used to associate workloads to the groups. For example, the tag “app” of a container can be used to define its group. A tag is a mechanism to associate a value and a key to different computing assets. A key could be, for example, “owner.” Values would be assigned to different resources and workloads to identify who is the owner. For example, if there are five computing systems, each would have a tag with the key “owner”. The first three computing systems might have a value of “Bob”, while the remaining two might have a value of “Evan”. The groups are the results of applying the rules (e.g. groups include app1, app2, app3). The membership is the association of workloads to groups (e.g. 1543 of the containers are members of the app1 group). In this way, some embodiments use a rule-based engine to correlate collected data from the shared infrastructure to associate one or more workloads running on the shared infrastructure with particular groups.

The correlated and associated data is then analyzed in a data analyzer 218 which assigns a value of the shared infrastructure to the group and may also measure that value against various assessment metrics. That is, the workloads determined to be associated with a group are aggregated based on a determined value allocation rule (e.g. aggregate up all the CPU cycles used by all the containers run in Elasticsearch group), and then a value allocation rule is applied to determine value (e.g. using the rule that we allocate costs proportional to CPU cycles, and our knowledge of costs for the shared infrastructure and CPU cycles used per container, compute total cost for the Elasticsearch group). Elasticsearch is used as an example of a cloud service that provides search, analytics and storage. In various embodiments, this value can include costs, number of assets, usage, performance, security, trends, optimizations, and/or histories of these various values. The analysis from the data analyzer 218 is provided to a results processor 220 that provides reports, policy management, governance, and initiates automated action functions based on the analysis provided by the analyzer 218.

One feature of the present teaching is that it allows a proportional allocation of resource consumption to various groups within an organization. The system provides a means to collect, process and store a set of workloads associated with a group and their resource consumption, and apply configurable rules to attribute the set of workloads to groups. The system further provides means to compute the proportional resource consumption attributable to different groups from the previously mentioned collected set of workload measurements. The system may optionally assign chargebacks to groups based on the proportional resource consumption of activities that have been attributed to them.

Another feature of the present teaching is that it can operate in a multi-tenant software environment as a Software as a Service (SaaS) environment, where multiple shared infrastructure installations can be reported on from a single instance of the system. For example, it can be all cloud, all on premise, or a hybrid in which the analysis/storage is in cloud, but collection occurs on-premise.

The computer-implemented method of the present teaching utilizes several core computer infrastructure constructs. These include a shared infrastructure, also referred to as a shared resource infrastructure. In various embodiments, the shared infrastructure comprises a variety of computing components, such as servers, containers, storage, memory, CPU's, and others. The shared infrastructure may be, for example, a collection of servers running in a cloud. The computer-implemented method also utilizes a construct referred to as a “value of shared infrastructure”. The value of shared infrastructure may be, for example, a cost of the aforementioned collection of servers running in cloud. The term “value of shared infrastructure” can be construed broadly in some embodiments to include any metric of interest or importance to the business, user or system that is valuing the shared infrastructure it is using. Another construct used by the computer-implemented method is an activity executing on the shared infrastructure. The activity may include, for example, workloads running in containers running on a collection of servers in a cloud.

Computer-implemented methods according to the present teaching can utilize a history of activity on a shared computer infrastructure. This may include, for example, a history of the workloads including elements, such as launch/terminate times, which servers they execute on, and/or details of the workload being executed. The history may also include what software application(s) was executed and where the software application was initiated. For example, the history may include what particular containers and which servers were used. The history can also include the metadata about this activity. An example of metadata is a marketing department analytics job. In addition, the history can include the resources consumed while the activity was executed. For example, the resources may be a number and identity of CPU(s) used, and/or a number and of memory used.

Computer-implemented methods according to the present teaching can also utilize value allocation rules which are rules by which value is proportionally attributed to a particular set of workloads. One example of the use of value allocation rules in the present teaching is allocating a proportion of CPU cycles used for a set of workloads. The computer-implemented method utilizes rule-based groups that are performing the set of workloads. These are declarative rules that define how the set of workloads is applied to groups. A specific example of its use is when a container task has a name “marketing analytics” and a tag env=“prod”, the rule would associate all activity with the Product A group.

Some embodiments of the system and methods of the present teaching use a collector. The term “collector” refers to a system that is capable of collecting information on an activity, or set of workloads, to allow recording of the history of activity. Collectors can also collect information on the shared infrastructure, such as infrastructure operation and performance metrics. For example, infrastructure information can include what VMs were run, the costs of running those VMs, system performance, usage and utilization information. This can be done through absolute collection if an authoritative record of all activity exists. Collection can also be done with sampling. These system and methods can utilize a processor system that receives collected data, maintains a history of activity, stores and implements the rule-based groups and value allocation rules, and performs the attribution of value to groups.

One feature of the system and method of the present teaching is that it is scalable. The system and method can scale within an organization (e.g. multiple data centers, multiple clouds, etc. . . ), and the system and method scale across multiple organizations (e.g. MSP delivering this as a service to multiple customers, each of which have their own data centers/clouds). In some embodiments, scalability of the system is achieved by running the different architectural components in different areas. For example, multiple collection and correlation nodes could be pushed to the various cloud environments for scalability.

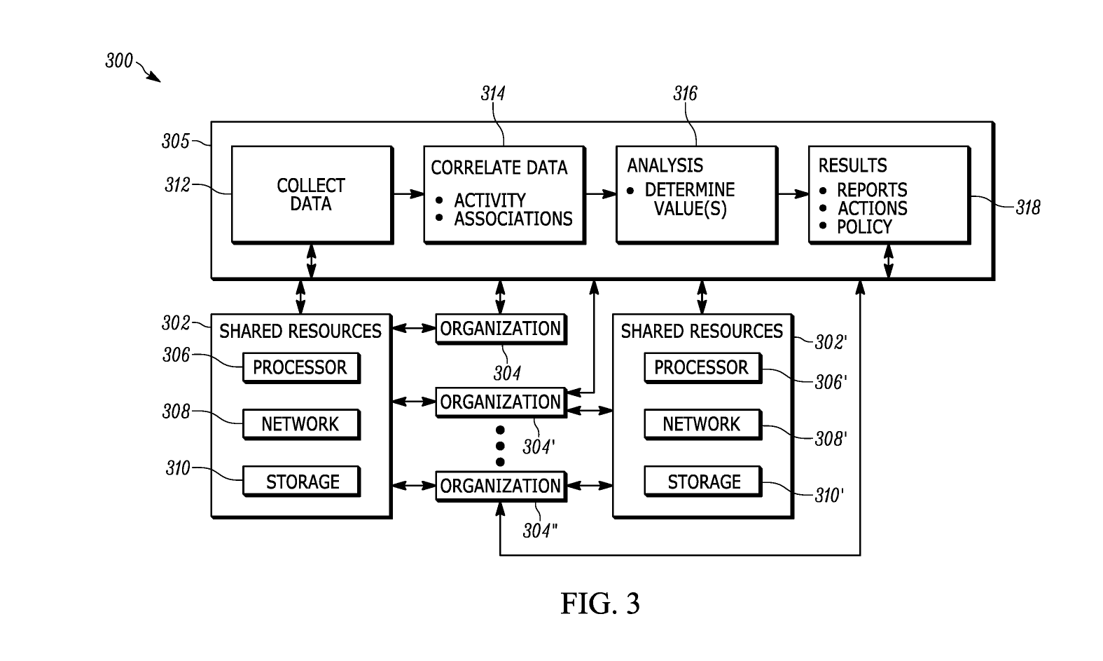

Another feature of the system and method of the present teaching is it can be applied to a large number of infrastructures and organizations simultaneously. The multiple infrastructures and organizations are often globally distributed. FIG. 3 illustrates a block diagram of an embodiment of a distributed system 300 of the present teaching. The system 300 includes multiple shared-resource facilities 302, 302′. For simplicity, only two resource facilities 302, 302′ are indicated in the figure but, it should be understood to those skilled in the art that the system can scale to any number of facilities. These shared-resource facilities 302, 302′ may be data centers, private clouds, public clouds and other known shared-resource facilities. The various shared resource facilities may be distributed globally, and connected by various public and private networks. The shared-resource facilities 302, 302′ include a variety of shared hardware components including processors 306, 306′ , networking equipment 308, 308′ and storage 310, 310′.

Multiple user organizations 304, 304′, 304″ are connected to the different shared resource facilities 302, 302′ and to a processor 305 using various public and/or private networks. The connections between user organizations 304, 304′, 304″ and shared-resource facilities 302, 302′ may vary over time. The equipment in the shared-resource facilities 302, 302′ runs various software services and applications that support virtualization that aids the sharing of the resources. For example, an organization 304, 304′, 304″ could be utilizing a number of virtualized machines, containers, and virtualized storage at the various shared-resource facilities 302, 302′ to which it is connected.

The shared-resource facilities 302, 302′ provide to a collector 312 in the processor 305 various data associated with the usage of the equipment and/or virtualized processing and services that are provided to the organizations 304, 304′, 304″. These data can include the number of assets, costs, and usage data. The organizations 304, 304′, 304″ can also maintain and provide to the collector 312 in the processor 305 data associated with activities performed using the infrastructure. In addition, various other software applications and services that monitor the infrastructure and applications running on the infrastructure produce data about the activities being services by the shared resources and share this data with the collector 312. These data may include configuration management data, fault, and performance management data, event management, security management, and incident and change management data.

Data associated with various activities ongoing in the multiple organizations 304, 304′, 304″ is collected by a collector 312. The data can be aggregated in some methods from multiple locations and/or applications and services that provide the data. The data can also be validated in some methods. For some types of shared infrastructure that does not provide internal event capture, such as Kubernetes (a commercially available open-source platform designed to automate deploying, scaling, and operating application containers), the state of the system is sampled by the collector 312 periodically for both activities and the resources they consume. The accuracy of data is determined by the frequency interval. For example, in one particular computer-implemented method, the default sample time is on order of once every 15 minutes.

A data correlator 314 in the processor 305 correlates data associated with one or more activities in one or more groups in the various organizations 304, 304′, 304″. A data analyzer 316 in the processor 305 then analyzes the data to determine a value of the activity to the groups. Group attribution rules define what expressions are used to evaluate an activity against. The first rule, which “captures” an activity, assigns the resource consumption of that activity to a group.

In one embodiment, the collector 312 collects data on the workloads, including, for example, costs, utilization, users, and other information about the workloads. Artifacts of the data may include, for example: workload 1234 ran on VM 6789 for ‘x’ period of time and used ‘y’ CPU cycles, and that workload 1234 has metadata project=“marketing”. The data correlator 314 correlates various artifacts in the data, and then assigns sets of workloads to groups based on user-defined group member rules and/or formulas. The data analyzer 316 uses value allocation rules and/or formulas to determine value on a per workload basis, and then aggregates this value per workload up to a value for a particular group by summing the aggregate value of all workloads associated with, or assigned to, a group. By performing data correlation and analysis on a full set of workloads that are running on a shared infrastructure, assigning different subsets of workloads to different groups based on the rule-based group member assignment, and determining the aggregate value of workloads for each of multiple groups, the system can assign and/or determine the proportional value to each group of that shared infrastructure.

A results engine 318 in the processor 305 may optionally assess the values of the activities for the various attributed groups to establish one or more results. The value can be a relative value and/or an absolute value. Results can include, for example, reports, actions and/or policies.

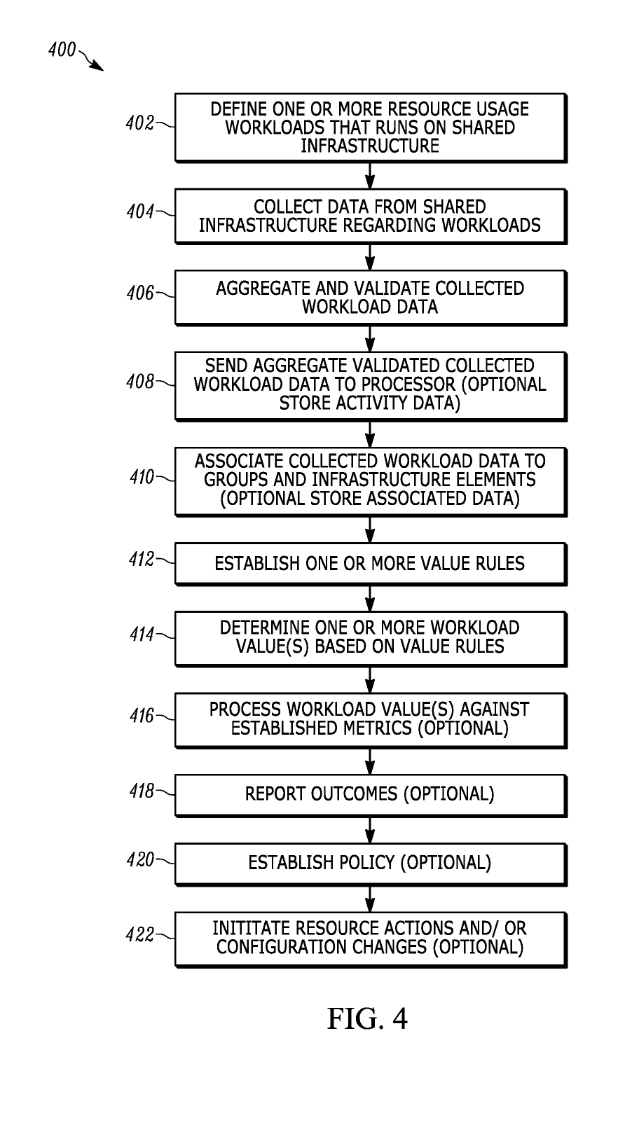

FIG. 4 illustrates a process flow diagram of an embodiment of a computer-implemented method 400 of the present teaching. In step one 402 of the method 400, one or more resource usage workloads are defined. The resource usage workloads run on a shared computer infrastructure. The workloads can be, for example, containers running software applications and services, or utilization of shared storage resources. The workloads may be defined for various durations. The workloads may be defined by automated processing and/or human in the loop. In step two 404 of the method 400, a collector gathers information on workloads running on the shared resource infrastructure. The collected data may be an absolute record of the workloads, or the collected data may be a sampled set of data about the workloads. The sampling rate may change over time and depend on the workloads. For example, in one specific embodiment, the sample rate is on order of every 15 minutes.

Referring also to FIG. 3, in step three 406 of the method 400, the collector 312 sends the data to an aggregator that validates and aggregates the collected workload data. In step four 408 of the method 400, the aggregated data is sent to a processor 305, where it may be used to maintain history of workloads by storing the events in a database. This history of workloads may be in the form incremental updates or current state, the latter of which requires performing a delta from previous known state to derive the change. In some embodiments, the collected workload data includes details of the workloads, such as what containers run what tasks, (e.g. container running task A) and any associated details of the consumption of resources for the workloads (e.g. CPU used). In some embodiments, workload data includes information on what applications and or services were run and where the applications and services were run (e.g. what containers execute and which servers they execute on). In some embodiments, the workload data includes metadata about this workload (e.g. marketing department analytics job). In some embodiments, the workload data includes the resources consumed while the workloads execute (e.g. CPU used, memory used).

In step five 410 of the method 400, the workload data is associated to groups and a set of computer infrastructure elements that supports the workloads. In some embodiments, a data correlator 314 in a processor 305 determines the associations. In some embodiments, the processor 305 will have knowledge of how to associate workloads with the members of the shared infrastructure on which it executes on. This may be derived from direct information in the data. For example, this information can be derived from a container that knows the server on which it executes. This information can also be derived indirectly from information in the data. For example, this information can be derived from metadata in a container associated with the server. In some embodiments, a data correlator 314 in the processor 305 derives knowledge of the shared infrastructure supporting the workloads. In many methods, the processor 305 knows which shared infrastructure was supporting the workloads in advance. The processor 305 will sometimes have rule-based groups on each workload that allows it to define membership in groups of different types of workloads. In general, no workloads can exist in more than one group. Rule-based groups processing can optionally be handled external to the processor 305. The processor 305 can simply retrieve the information about the groups from the external source. For example, a rule-based grouping engine could maintain continuous computation of membership of workloads to groups based on rule-based groups.

In step six 412 of method 400, the processor 305 establishes one or more value rules. The value allocation rule may be predetermined. The value allocation rule may be input by a user. In step seven 414 of the method 400, the processor 305 establishes a value for a set of workloads based on those rules. In some embodiments, the processor 305 will look up or have access to a value for each member of shared infrastructure. For example, the value can be how much the server cost for its duration of running. In some embodiments, the processor 305 will have predefined value allocation rules that allow it to attribute proportional value for shared infrastructure based on the set of workloads (e.g. proportional to CPU consumed). In some embodiments, the processor 305 will then calculate the group membership for all workloads. This information can also be fetched by processor 305 from external system. Using, for example, the group membership, knowledge of the relationship between a set of workloads and the activities shared infrastructure members and the history of the set of workloads on the shared infrastructure, the processor 305 can then attribute proportional value based upon the value allocation rules. An example of knowledge of the relationship between a set of workloads and the activities, shared infrastructure members is, for example, which containers in group X ran on which servers and for how long.

In optional step eight 416 of the method 400, the processor 305 assess the values against established value metrics to provide outcomes. In optional step nine 418 of the method 400, the processor 305 can report outcomes. In optional step ten 420 of the method 400, the processor can then establish policies for usage of the shared infrastructure. Finally, the processor 305 can initiate resource actions and/or configuration changes in optional step eleven 422 based on the outcomes of the method 400.

In some embodiments, the determined value of the shared infrastructure to a group may be used to improve the sizing of a cluster and/or container to improve the efficiency of a shared infrastructure.

In some embodiments of the system and computer-implemented method of the present teaching, the processor 305 can produce an aggregation that combines the results from the data analyzer 316 (or other analyzer engine) and from the data correlator 314 (or other categorization engine) to generate summarized information. Such summarized information can be generated as a function of time. Such summarized information can also be generated as a function of other dimensions, including, for example, aggregate provisioned resource levels as they vary over time, categorized by the provisioned resource groupings. The information may also be generated as aggregate consumed resource levels as they vary over time, categorized by the workload characteristics, especially the ascribed grouping.

Many embodiments of the system and computer-implemented method of the present teaching utilize various proprietary and open source software applications and services to obtain data and information needed to implement various steps of the methods within the scope of the present teaching. For example, Kubernetes, which is an open-source platform designed to automate deploying, scaling, and operating application containers, provides a system whereby tasks can be described as an image and required resources, such as amount CPU cores, memory in GB etc. Kubernetes then arranges for the task to be placed on node with sufficient available resources and initiates the task. The task will then runs to completion. It is understood that tasks can run for a relatively short time duration (seconds) to relatively long time durations (months).

Thus, the system and computer-implemented methods described according to the present teaching can be used to collect, process, and analyzes task placement and duration. The methods can apply rules to attribute each task to a group and then collates the Resource*Seconds (CPU*seconds, Gb *Second) from all applicable tasks to their groups. The resulting information, while useful in and by itself, can then be further combined with cost information obtained from external systems to allocate proportional costs of performing the various activities by the various groups. It is important to note that in many environments where the system and computer-implemented method of the present teaching can be implemented, the shared infrastructure itself is dynamic and changes in capacity based on the submitted work.

One feature of the system and computer-implemented method of the present teaching is that it allows organizations to answer questions such as: (1) over a particular time duration, to which types of tasks, and to which groups have resources been allocated; (2) are tasks for a given group consuming disproportionately more resources than other groups; and (3) what proportional cost of the shared infrastructure should be attributed to which groups?

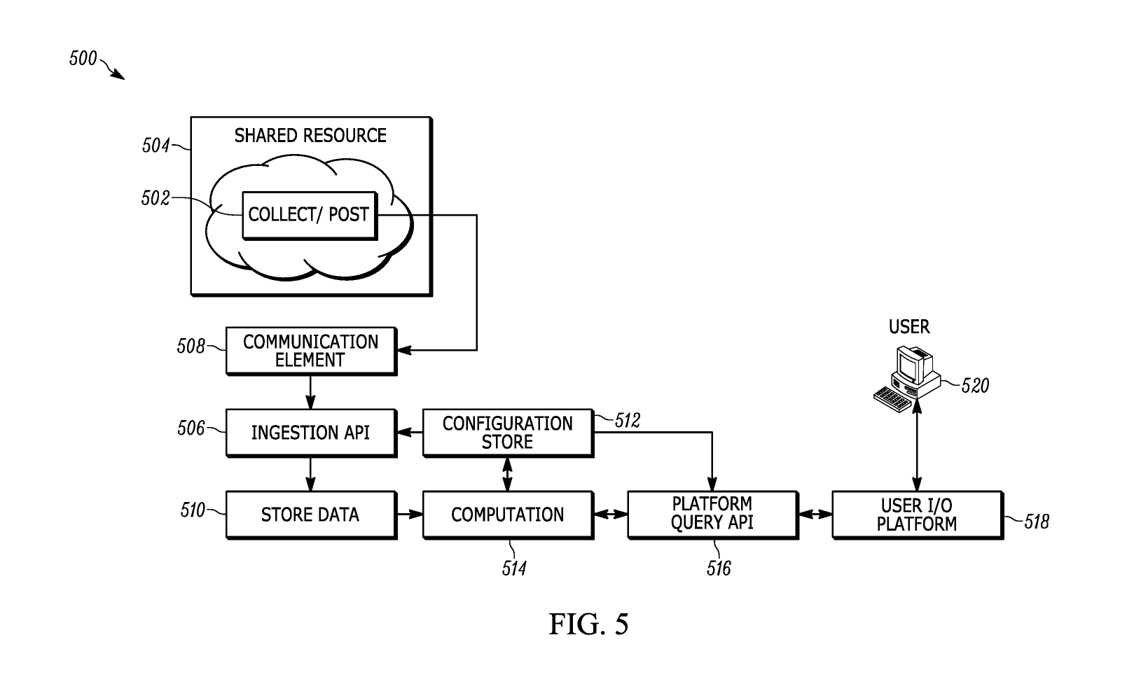

FIG. 5 illustrates an architecture diagram of an embodiment of a system 500 of the present teaching. A collect/post system 502, which in some embodiments operates in a cloud-based shared resource infrastructure 504, contacts the applicable controllers for the shared infrastructure 504. For example, the applicable controllers can include Mesos Master and/or Kubernetes Master, both of which control services to enable fine-grained sharing of computer resources. The collect/post system 502 can be on the customer-side of the system. The collect/post system 502 reports raw data to an ingestion application programming interface (API) 506. The collect/post system 502 is connected to the ingestion API 506 by a communication element 508. In some embodiments, the communication element 508 is an application load balancer (ALB) networking component which delivers the incoming data to one of many available instances of the ingestion API 506 in a round-robin fashion.

The ingestion API 506 is responsible for storing incoming data in a time-series document store in memory 510. The ingestion API 506 uses the data from a configuration store 512 to validate that the data is authentic, and identifies the tenant/environment from which the data is being reported. A computation element 514, such as a multidimensional Online Analysis Processing (OLAP) element, performs processing and analysis on the data persisted in the time-series store 510 and generates intermediate representation of the analysis results. A platform query API 516 exposes the results of analysis performed by the computation element 514 to an input/output platform 518, such as a webserver platform, which presents it on demand to users 520.

As described herein, the system and computer-implemented method of the present teaching operates with various forms of shared computer infrastructure. This includes computer infrastructure operated by third-parties on which tasks and activities execute. Examples include Mesos, Kubernetes, and Amazon EC2 container services (e.g. ECS container cluster). Task owners submit tasks to the shared infrastructure. These tasks comprise the defined activities of the computer-implemented method. In some embodiments, the system interacts with the shared computer infrastructure to collect its state in at least two ways. First, the system samples the current state periodically. Second the system consumes events produced by the shared infrastructure.

One feature of the system and computer-implemented method of the present teaching is that users can interact with the system in various and significantly different ways. For example, users can instrument the computer infrastructure to provide information to the system in different ways. The users can install a collector into the environment or the users can configure the environment to deliver events to the system. The users can also configure rules identifying which tasks and/or underlying activities belong to each group. The users can extract reports from the system. These reports can take various forms, including reports which attribute resource consumption to different groups, and reports which allocate cost based on resource consumption to different groups.

In order to allocate cost to computer resources, the system consumes information identifying the cost of the provisioned shared infrastructure. These costs can be consumed from, for example, a public cloud provider. The costs can be calculated by allocating costs from other sources. An example, of the other sources is servers in a customer's environment where the cost can be directly assigned by the administrators of those systems.

### Equivalents

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A computer-implemented method of determining value of a shared computer infrastructure to a group, the method comprising:
a) collecting data from the shared computer infrastructure;
b) determining an association between one or more workloads and the group based on the collected data using a rule-based engine; and
c) determining a value to the group of the one or more workloads based on a value allocation rule.

2. The computer-implemented method of determining value of the shared computer infrastructure to the group of claim 1 further comprising aggregating the collected data.

3. The computer-implemented method of determining value of the shared computer infrastructure to the group of claim 1 wherein the shared computer infrastructure comprises a plurality of servers running in a data center.

4. The computer-implemented method of determining value of the shared computer infrastructure to the group of claim 1 wherein the shared computer infrastructure comprises a plurality of cloud computing resources running on a cloud.

5. The computer-implemented method of determining value of the shared computer infrastructure to the group of claim 4 wherein the cloud comprises a private cloud.

6. The computer-implemented method of determining value of the shared computer infrastructure to the group of claim 4 wherein the cloud comprises a public cloud.

7. The computer-implemented method of determining value of the shared computer infrastructure to the group of claim 4 wherein the cloud comprises a hybrid cloud.

8. The computer-implemented method of determining value of the shared computer infrastructure to the group of claim 1 wherein the collected data comprises usage data.

9. The computer-implemented method of determining value of the shared computer infrastructure to the group of claim 1 wherein the collected data comprises configuration management data.

10. The computer-implemented method of determining value of the shared computer infrastructure to the group of claim 1 wherein the collected data comprises security data.

11. The computer-implemented method of determining value of the shared computer infrastructure to the group of claim 1 wherein the collected data comprises availability data.

12. The computer-implemented method of determining value of the shared computer infrastructure to the group of claim 1 wherein the collected data comprises workload data.

13. The computer-implemented method of determining value of the shared computer infrastructure to the group of claim 1 wherein the collected data comprises a set of containers supporting the one or more workloads.

14. The computer-implemented method of determining value of the shared computer infrastructure to the group of claim 1 wherein the collected data comprises available shared resource components in the shared computer infrastructure.

15. The computer-implemented method of determining value of the shared computer infrastructure to the group of claim 1 wherein the collected data comprises consumed computer resource components in the shared computer infrastructure.

16. The computer-implemented method of determining value of the shared computer infrastructure to the group of claim 1 wherein the collected data comprises a cost of a server for a duration of at least one of the one or more workloads.

17. The computer-implemented method of determining value of the shared computer infrastructure to the group of claim 1 wherein the group comprises a group of users of the shared computer infrastructure in a particular line of business.

18. The computer-implemented method of determining value of the shared computer infrastructure to the group of claim 1 wherein the group comprises a software application.

19. The computer-implemented method of determining value of the shared computer infrastructure to the group of claim 1 wherein the rule-based engine comprises a rule-based grouping engine that maintains a continuous computation of membership of workloads to groups.

20. The computer-implemented method of determining value of the shared computer infrastructure to the group of claim 1 wherein determining the association between the one or more workloads and the group based on the collected data using the rule-based engine comprises determining an association between the one or more workloads and the group based on metadata in a container.

21. The computer-implemented method of determining value of the shared computer infrastructure to the group of claim 1 wherein the value allocation rule comprises a rule that allocates a proportion of CPU cycles used for a set of workloads.

22. The computer-implemented method of determining value of the shared computer infrastructure to the group of claim 1 wherein the value to the group of the one or more workloads is determined based on a forecast of a future value.

23. The computer-implemented method of determining value of the shared computer infrastructure to the group of claim 1 further comprising determining a history of the one or more workloads and then determining the value to the group of the one or more workloads using the determined history of the one or more workloads.

24. The computer-implemented method of determining value of the shared computer infrastructure to the group of claim 1 wherein the group comprises a plurality of groups and the determining the value to the group of the one or more workloads comprises determining a plurality of values.

25. The computer-implemented method of determining value of the shared computer infrastructure to the group of claim 1 further comprising comparing the determined value to the group of the one or more workloads against a value metric.

26. The computer-implemented method of determining value of the shared computer infrastructure to the group of claim 25 wherein the value metric comprises a predefined cost.

27. The computer-implemented method of determining value of the shared computer infrastructure to the group of claim 25 wherein the value metric comprises a predefined time to completion of a task.

28. The computer-implemented method of determining value of the shared computer infrastructure to the group of claim 25 wherein the value metric comprises a predefined number of provisioned resources.

29. The computer-implemented method of determining value of the shared computer infrastructure to the group of claim 1 further comprising generating a resource configuration change based on the determined value to the group.

30. The computer-implemented method of determining value of the shared computer infrastructure to the group of claim 1 further comprising storing the collected data.

31. The computer-implemented method of determining value of the shared computer infrastructure to the group of claim 1 wherein the collecting data from the shared computer infrastructure comprises receiving events delivered by the shared resource infrastructure.

32. The computer-implemented method of determining value of the shared computer infrastructure to the group of claim 1 wherein the collecting data from shared computer infrastructure comprises collecting workload data at predetermined time intervals.

33. A computer system for determining value of a shared computer infrastructure to a group, the computer system comprising:
a) a shared computer infrastructure;
b) a collector electrically connected to the shared computer infrastructure, the collector being configured to collect data from the shared computer infrastructure; and
c) a processor having an input electrically connected to an output of the collector, the processor receiving the collected data from the collector and being configured to determine an association between one or more workloads and the group based on the collected data using a rule-based engine and configured to determine a value to the group of the one or more workloads based on a value allocation rule.

34. The computer system of claim 33 wherein the collector aggregates the collected data.

35. The computer system of claim 33 wherein the collector comprises a processor executing on the shared computer infrastructure.

36. The computer system of claim 33 further comprising a load balancer electrically connected between the output of the collector and an input to the processor.

37. The computer system of claim 36 wherein the load balancer provides the data to the processor in a round-robin fashion.

38. The computer system of claim 33 further comprising a memory electrically connected to the processor, the memory storing a time-series representation of the collected data.
